(19) United States
(12) Patent Application Publication
(10) Pub. No.: US 2011/0147563 A1
(43) Pub. Date: Jun. 23, 2011

(54) VIBRATION DAMPING OF A CEILING MOUNT CARRYING A SURGICAL MICROSCOPE

(75) Inventor: Andrzej Metelski, Romanshorn (CH)

(73) Assignee: LEICA MICROSYSTEMS (SCHWEIZ) AG, Heerbrugg (CH)

(21) Appl. No.: 12/967,314

(22) Filed: Dec. 14, 2010

(30) Foreign Application Priority Data
Dec. 20, 2009 (CH) 0059/10
Dec. 21, 2009 (DE) 10 2009 059 021.8

(51) Int. Cl. F16M 13/02

(52) U.S. Cl. 248/610

(57) ABSTRACT

The present invention relates to a ceiling mount for a surgical microscope, including at least two load-bearing sections joined together by a damping interface, said interface including at least two damping layers which are made of damping material and are separated from each other by a bracket plate made of non-damping material. In order to damp a wider spectrum of mechanical disturbances even more efficiently, the material of one damping layer has other elastic properties than the material of the other damping layer.

### CROSS REFERENCE TO RELATED APPLICATIONS

This application claims priority of Swiss patent application no. 0059/10 filed Dec. 20, 2009 and German patent application number 10 2009 059 021.8 filed Dec. 21, 2009, the entire disclosures of which are incorporated by reference herein.

### FIELD OF THE INVENTION

The present invention relates to a ceiling mount for a surgical microscope, including at least two load-bearing sections joined together by a damping interface, said interface including at least two damping layers which are made of damping material and are separated from each other by a bracket plate made of non-damping material.

### BACKGROUND OF THE INVENTION

The use of ceiling mounts involves the problem of vibrations or vibration feedback which may occur, on the one hand, when the ceiling vibrates and/or when the instrument (e.g. a microscope) is touched or moved and, on the other hand, as a result of operation or movement of control consoles which are associated with the instrument and also suspended from the ceiling mount. Ceiling vibrations generally occur unpredictably and may be caused by various sources, such as compressors, air-conditioning systems, engines, and also seismic vibrations, or vibrations caused by transport of masses, such as occur during passage of a heavy vehicle thereabove, or during landing of a helicopter on the roof, or the like.

In the case of floor stands, contact-induced vibrations can be controlled, for example, by support feet made of mechanically damping materials, whereas in the case of ceiling mounts, there is a phenomenon which cannot be easily eliminated in a similar fashion, as will be described below. The ceiling of an operating room generally vibrates at different frequencies and amplitudes with respect to the floor. Therefore, it is insufficient to merely damp natural vibrations excited by contact or movement. The inventor has recognized that when a ceiling mount is used, it is required to damp not only the natural vibration of the mount, but also the vibration excited by the ceiling itself. In the prior art, it is known to provide a damping interface between the building element and the instrument. The effect of the interface is that vibration processes occurring before and behind it are different and ideally cancel each other out. The arrangement of the damping layers at horizontal interfaces has been described and implemented. These approaches aimed at the damping of natural vibrations. Damping of vibrations excited by the ceiling has not yet been described.

European Patent EP 1 067 419 B1 discloses a damped swing arm on a ceiling mount, in which a damping interface is provided between sections of a support arm which are pivotable relative to each other. The interface includes at least two identical damping layers separated by a non-damping layer. The rigid and elastic layers form a kind of sandwich element. The housing of this sandwich element is rigidly joined to the first section of the support arm, and the non-damping layer is rigidly joined to the second section of the support arm. The damping layers are made of a uniform elastomeric material.

Some of the following patent publications, which are more remote from the present invention, also deal with damping elements for surgical microscopes.

European Patent 1 248 133 B1 discloses a microscope stand having a vertical column and a horizontal support arm which is pivotable about the axis of the column of the stand. The means provided for vibration damping are in the form of a torsional damping element adapted to counteract torsional forces caused by horizontal pivoting movements of the support arm relative to the vertical column of the stand. This torsional damping element is kept free of axial forces and is loaded solely in shear.

In the context of surgical microscopes, Patent Publications DE 10 2006 044 469 A1 and US 2008 0 055 739 A1, as well as US 2008 0 058 109 A1, describe a drive motor driving a carriage, which in turn interacts with the zoom system of a surgical microscope. The drive shaft of the motor is connected to the carriage via an elastomeric damper.

German Patent Application DE 10 2008 011 311 A1 discloses a ceiling mount which also addresses the issue of vibration damping. In that patent, however, the problem of vibration damping is solved by a horizontally movable carriage. The movable carriage has associated therewith a mechanical end stop having a rubber buffer. However, the carriage of this known ceiling mount, too, has a vibration damping effect only for natural vibrations caused by movement of the microscope.

Thus, due to the large weight of the mount and the instrument suspended therefrom which, in total, may exceed 400 kg, conventional ceiling mounts have the disadvantage that vibrations, including both natural vibrations and vibrations of the ceiling, are not sufficiently damped. Typically, the microscope is mounted on the end of a usually multi-part support arm. A counterweight is provided to maintain the center of gravity of the overall system substantially below the ceiling attachment point. Moreover, an equipment box may be provided, either separately or as part of said counterweight, allowing basic settings to be made for the overall system. Thus, natural vibrations are involuntarily caused, on the one hand, by controlling or moving the microscope and/or the microscope support arm, and on the other hand by manipulation of the equipment box. The damping elements previously used in the arms may have been effective for vibrations originating at the microscope itself, but there has heretofore been no causal damping of vibrations originating at the control box. Moreover, previous designs were not effective for vibrations of the ceiling. In this context, ceiling vibrations are understood to include not only those mentioned above, but also vibrations which may be accidentally caused by equipment on the ceiling or in the room and introduced into the stand via the ceiling.

Although the prior art has provided various damping interfaces, there is still an enormous need for improvement since the high weight of the overall system and the resulting quantity of energy to be dissipated exceed the capabilities of known approaches. In addition, in particular, in operations which are performed under optical magnification to ensure pinpoint accuracy, such as in neurosurgery, eye surgery, etc., high accuracy is crucial for successful results. Regardless of their causes, unwanted vibrations can negatively affect the surgery and the surgeon's performance and ability to concentrate. This is particularly because vibrations may interfere with the sharpness and quality of the image, and may therefore place continued excessive strain on the surgeon's visual system.

### SUMMARY OF THE INVENTION

It is an object of the present invention to overcome these disadvantages and to provide a ceiling mount which will efficiently suppress the above-mentioned vibrations, regardless of their causes. However, the complexity of construction and manufacture should not be increased over known ceiling mounts. Another object is to ensure long-term reliability.

The present invention achieves these objects by providing a ceiling mount of the above-mentioned type in which the separate damping layers have different elastic properties. The use of different materials, and thus different elastic properties, for the two damping layers tremendously improves the damping characteristics of ceiling mounts.

The two ceiling mount sections are decoupled from each other by the interface and are typically constructed as follows: The upper section is anchored to the ceiling by a ceiling attachment means of the ceiling mount and provides the support or housing for the interface, and thus for the damping layers. The support or housing includes two plates or disks of rigid material (steel, aluminum, etc.) adapted to compressively sandwich the system of damping layers and the bracket plate therebetween. The lower section, from which the support arms and the medical instrument are suspended, is rigidly joined to, or forms a unit with, the bracket plate which separates the two damping layers. In other words, two damping layers compressively hold the load-bearing bracket plate therebetween, so that the bracket plate is acted upon by damping material both from above and from below. Thus, the bracket plate carries the entire weight of the ceiling mount.

This ceiling mount design provides a kind of spring-mass system, in which the mass is constituted by the lower section and the microscope, which, together, are connected to the upper section by two springs, namely the two damping layers. The provision of different materials having different damping properties made it possible to increase the energy dissipation in the interface and to significantly reduce the effect of vibrations, regardless of their causes.

In a preferred embodiment, the material of the lower damping layer has a higher modulus of elasticity than the material of the upper damping layer. As a first consideration, it may be noted that the lower damping layer bears the large weight of the entire instrument and the support arms, and, therefore, is preferably somewhat more rigid, while the upper, softer damping layer does not carry any load, but merely presses resiliently against the bracket plate from above. In reality, the effect achievable by the present invention is a combined effect of the damping action of both damping layers. The contributions of the individual damping layers to the overall damping effect vary depending on the nature and spatial orientation of the vibration and its excitation frequency. This makes it possible to cover a wide spectrum of mechanical disturbances and to efficiently damp such disturbances. These disturbances include not only vibrations acting vertically on the damping layers, but also those acting in a horizontal direction, in which the bracket plate may possibly also be excited to vibrate. Consequently, it must be ensured that the bracket plate is movable in all spatial directions within the two damping layers without exceeding the elastic properties thereof. With this configuration, it is also possible to efficiently damp low frequencies, for example, in the range of 4-10 Hz. Frequencies in the range of the power grid frequency, i.e., 50 or 60 Hz, are also efficiently damped in this way.

Further preferred embodiments are indicated in the subclaims and will be described below in more detail with reference to the drawings, in which:

### BRIEF DESCRIPTION OF THE DRAWINGS

FIG. 1 is an overall view of a ceiling mount according to the present invention shown together with an instrument;

FIG. 2 is a detail view of the damping interface;

FIG. 3 is an exploded view of the damping interface;

FIG. 4 is a schematic diagram of the interface; and

FIG. 5 is a view showing the interface in a condition where it is subjected to stress caused by tilting motion; and

FIG. 6 is a schematic view of a ceiling mount according to another embodiment of the present invention.

### DETAILED DESCRIPTION OF THE INVENTION

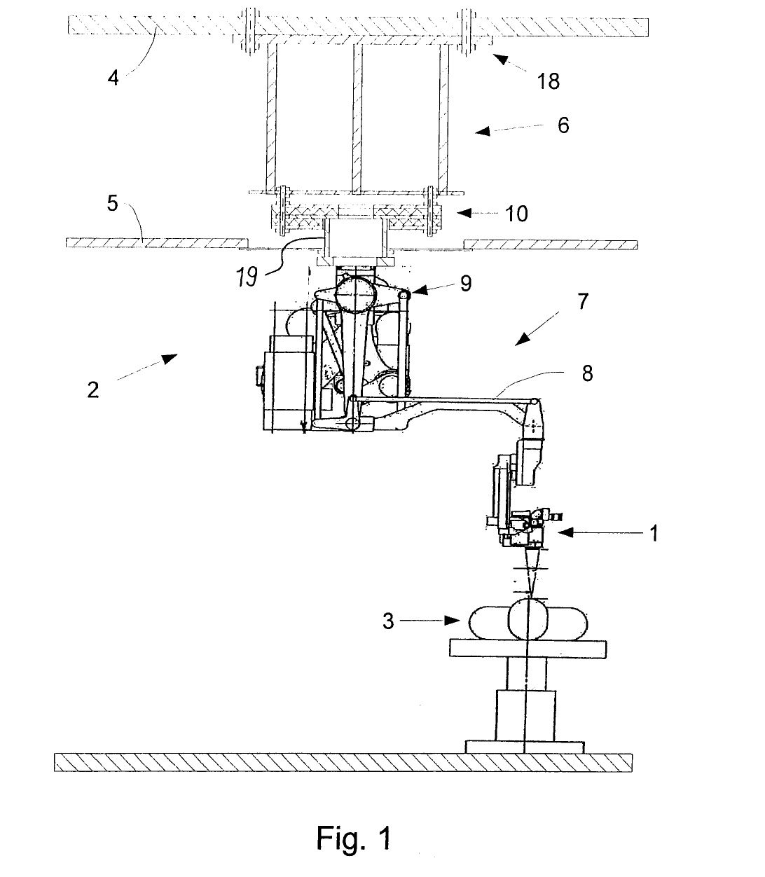

FIG. 1 shows a surgical microscope 1 suspended above a patient 3 from a ceiling mount 2. Ceiling mount 2 is attached to a ceiling 4 (steel, concrete, reinforced concrete, or the like). Also shown is an intermediate ceiling 5, which is optional. In the region of intermediate ceiling 5, or slightly thereabove or therebelow, ceiling mount 2 has an interface 10 which has a damping function and which decouples section 6 located thereabove from section 7 located therebelow. The mounting position of this interface is variable and depends, inter alia, on the length of the vertical portion of the stand. In lower section 7, there extends a multi-part support arm 8 carrying microscope 1 on its end. Also shown is an articulation mechanism 9 serving for the movement and mass-balancing of microscope 1.

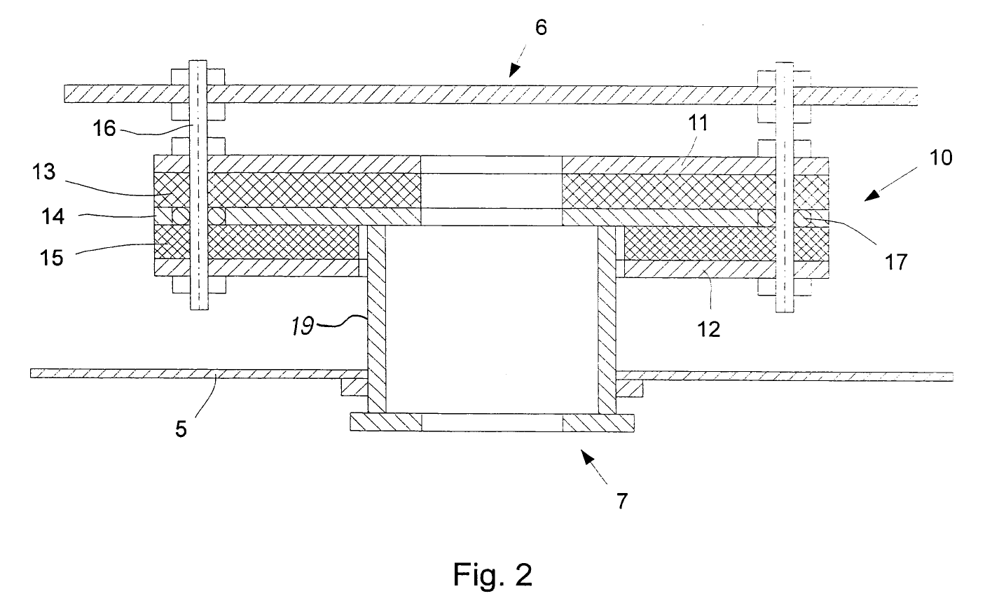

Damping interface 10, which is shown enlarged in FIG. 2, serves to rapidly damp or prevent the transmission of vibrations via the bracket plate to ceiling mount 2, regardless of the direction from which they come. Thus, the interface constitutes a damping element and is constructed as follows: Two disks or housing plates 11, 12 are provided as a housing or boundary, said disks or housing plates delimiting interface 10 at the top and at the bottom. Although the term “housing” is used here, such housing may in fact be open at its sides. Two disk-shaped damping layers 13, 15 made of damping materials are provided in the area between the plates, and are separated from each other by a non-damping bracket plate 14.

Bracket plate 14 defines the beginning of lower section 7 of the ceiling mount. That is, the lower section of ceiling mount 2 is rigidly joined to the bracket plate, forming a unit therewith. Non-damping bracket plate 14 is made of a rigid material, such as steel, aluminum, or other metal alloys. A skirt rigidly joined to non-damping bracket plate 14 extends through a, for example, circular opening in lower damping layer 15 and provides a mounting flange for connection with the support arm system.

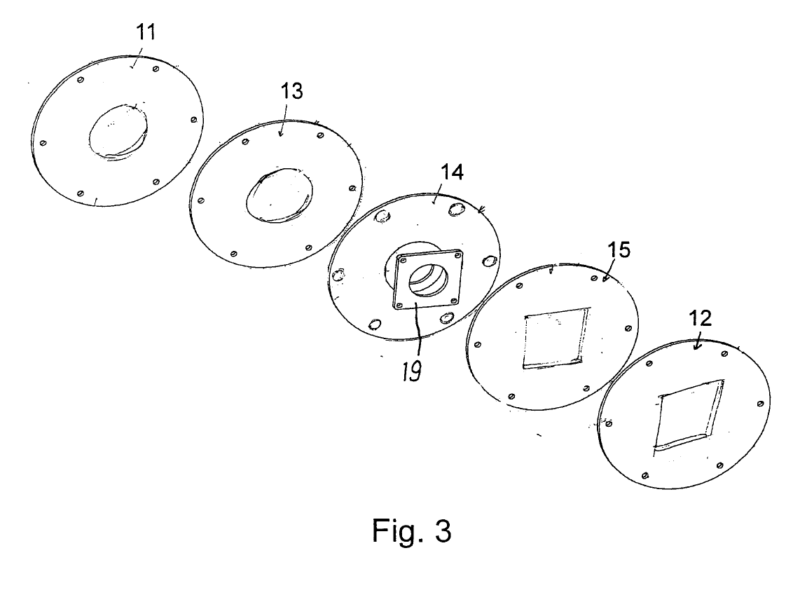

Thus, damping element 10 of ceiling mount 2 has a sandwich configuration. This is shown more clearly in the exploded view of FIG. 3. The sandwich structure is held together by connecting or clamping bolts or rods 16, which are spaced around the circumference and extend through all layers 11, 12, 13, 15 and bracket plate 14. Outer plates 11, 12 compressively hold layers 13 and 15 and bracket plate 14 therebetween. In order to prevent non-damping bracket plate 14 from striking against clamping bolts 16, the bores in bracket plate 14 are made sufficiently wide and O-rings 17 are provided to surround clamping bolts 16. In the event of vibration, these O-rings generate additional damping forces. This design is particularly advantageous because elastomeric damping layers damp particularly well when they are preloaded. The preload for lower damping layer 15 is primarily provided by the weight of the stand, while the preload for upper damping layer 13 is generated by the clamping forces of the connecting bolts, which act upon damping layer 15 via plate 12.

As an alternative to this type of connection, it would, of course, also be possible to use a housing that completely encloses the sandwich structure. In such an embodiment, the damping layers may also be produced at a later stage using casting or foaming techniques. From a vibration standpoint, non-damping bracket plate 14 forms part of lower section 7 of the ceiling mount. Moreover, bracket plate 14 has a downwardly projecting extension 19 provided with mounting holes for attachment of further platforms, bracket members, support arms, etc.

What is essential to the present invention is that the two damping layers 13, 15 be made of different materials with different elastic properties. In a particularly preferred exemplary embodiment, the damping layers are made of polyurethane (PUR) elastomers having open and closed cells. In a particularly preferred embodiment, the upper disk (layer 13) was made from the elastomer Sylomer® SR 450, and the lower disk (layer 15) was made from the elastomer Sylomer® HD 500.

Sylomer® SR 450 is suitable for a static range of use up to about 0.45 N/mm², the static modulus of elasticity in this range being between about 3 N/mm² and 5 N/mm². The dynamic range of use is up to about 0.7 N/mm², the dynamic modulus of elasticity in this range assuming values between about 4.5 N/mm² and 7 N/mm² (at frequencies of about <20 Hz). The mechanical loss factor (the ratio of energy dissipation and deformation work per cycle) of Sylomer® SR 450 is about 0.11.

Sylomer® HD 500 is suitable for a static range of use up to about 0.5 N/mm², the static modulus of elasticity in this range being between about 5 N/mm² and 7 N/mm². The dynamic range of use is up to about 0.7 N/mm², the dynamic modulus of elasticity in this range assuming values between about 5 N/mm² and 30 N/mm² (at frequencies of <20 Hz). The mechanical loss factor of Sylomer® HD 500 is about 0.5.

All values given above and all the following values are understood to understood to be in accordance with DIN 53513 and apply for a form factor of about q=3. The form factor is a geometric measurement for the form of an elastomer bearing and is defined as the quotient of the loaded surface to the exterior housing surface of the bearing. Of course, this does not exclude the possibility of using layers having other form factors for the purposes of the present invention. For the purpose of comparison, corresponding elasticity-related values are to be adapted accordingly.

These and other suitable Sylomer® materials are available from the Getzner Werkstoffe Company in Burs, Austria.

Of course, the present invention is not limited to these materials and parameters. For example, good results were also obtained with parameters different from those mentioned above. Since the entire load of lower section 7 of ceiling mount 2 rests on the lower disk (layer 15) (which implies a greater preload), it has proven advantageous to use the material of higher modulus of elasticity there and not at the upper side of the bracket plate 14. Further optimization is possible when one of the two damping materials, especially the lower material which takes up the entire load, has a higher mechanical loss factor than the upper material.

Within the scope of the present invention, hardly any restrictions are imposed on the material properties since the optimum design of the damping interface is dependent on the weight and construction of the instrument and the support arms. However, for use with surgical microscopes, the following parameter ranges have been found to be preferable:

In the working range used, the material of upper damping layer 13 has a static modulus of elasticity between about 2 N/mm² and 6 N/mm², particularly preferably between about 3 N/mm² and 5 N/mm². The material of lower damping layer 15 has a static modulus of elasticity between about 4 N/mm² and 10 N/mm², particularly preferably between about 5 N/mm² and 6 N/mm².

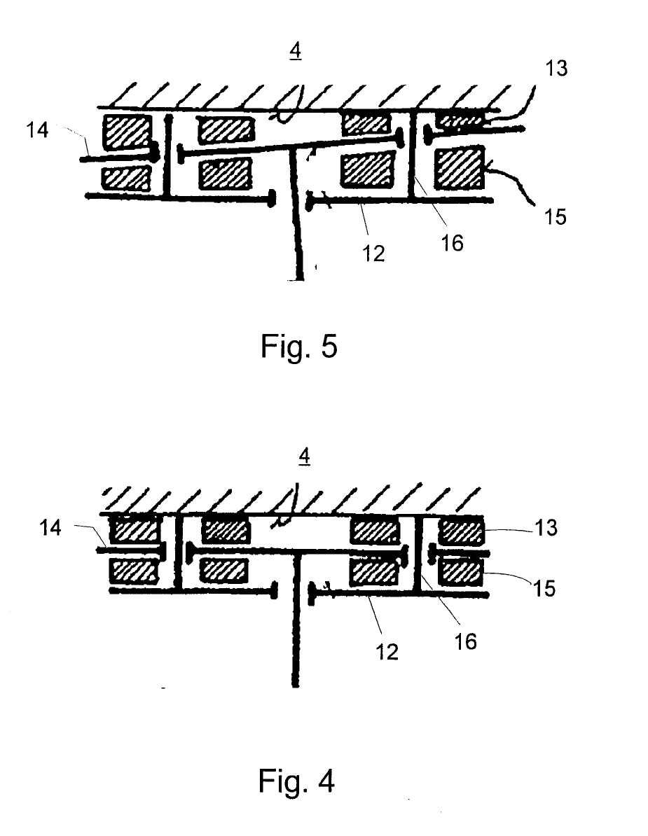

In FIGS. 4 and 5, the principle of the present invention is illustrated in exaggerated schematic views. Damping layers 13, 15, which are made of different materials and thus have different elastic properties, cooperate and both contribute to the damping of unwanted vibrations. In FIG. 4, the layers are parallel to each other. This could be the unloaded condition or a condition in which the disturbing forces at the interface act uniformly in a vertically downward direction.

FIG. 5 shows a different possible disturbance action, namely the tilting of non-damping bracket plate 14 between damping layers 13 and 15. In addition, interface 10 may also be loaded in torsion about a vertical axis. In reality, all of these disturbances are damped. The damping layers made of different materials cooperate in a corresponding manner, the contribution of a particular material to the overall damping effect varying depending on the type of disturbance. In other words, the inventive idea of choosing different materials made it possible to cover a larger spectrum of mechanical disturbances even more efficiently. In particular, it was possible to damp the different vibrations excited by the operating personnel and the ceiling, and to do so equally efficiently.

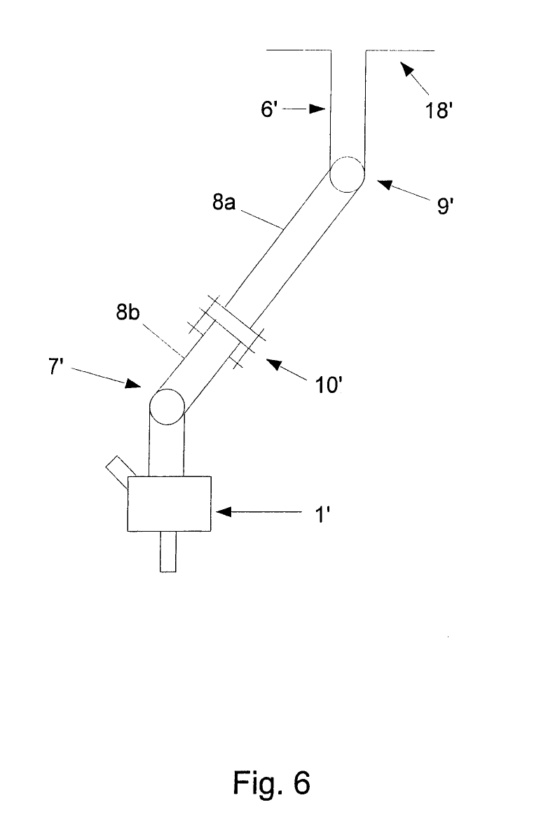

The present invention is not limited to the exemplary embodiment shown herein. In contrast to FIG. 1, an interface according to the present invention may also be provided at a different location on the ceiling mount, such as between two support arm members. Such an embodiment is illustrated schematically in FIG. 6, wherein damping interface 10′ is located between two support arm members 8a and 8b. Depending on the particular application, the layers may also have an orientation other than horizontal.

It is also conceivable to employ more than two damping layers. In this case, different materials having different elastic properties may alternate, it being preferable to provide a non-damping bracket plate therebetween respectively.

It is also within the scope of the present invention to attach the interface directly to the ceiling; i.e., without upper section 6.

Furthermore, in the context of the present invention, the term “ceiling” is understood to refer to all substantially horizontal structural elements of a building, including those which do not cover a room.

The ceiling 4 shown in FIGS. 4 and 5 may alternatively represent a ceiling attachment means 18 or upper load-bearing section 6.

### LIST OF REFERENCE NUMERALS

1, 1′ surgical microscope

2 ceiling mount

3 patient

4 ceiling

5 intermediate ceiling/suspended ceiling

6, 6′ upper load-bearing section

7, 7′ lower load-bearing section

8 support arm

8a, b members of a support arm

9, 9′ articulation mechanism

10, 10′ damping interface

11 upper housing plate

12 lower housing plate

13 upper damping layer

14 bracket plate

15 lower damping layer

16 clamping bolt

17 O-ring

18, 18′ ceiling attachment means

19 downward extension

What is claimed is:

1. A ceiling mount for a surgical microscope, comprising:
a damping interface including at least two damping layers made of damping material and a bracket plate made of non-damping material arranged to separate the at least two damping layers from each other; and
at least two load-bearing sections joined together by the damping interface, wherein a first load-bearing section of the at least two load-bearing sections is adapted for attachment to a ceiling and a second load-bearing section of the at least two load-bearing sections is rigidly joined to the bracket plate of the damping interface;
wherein the material of one of the at least two damping layers has different elastic properties than the material of another of the at least two damping layers.

2. The ceiling mount as recited in claim 1, wherein the material of one damping layer has a higher static modulus of elasticity than the material of the other damping layer.

3. The ceiling mount as recited in claim 1, wherein the material of one damping layer has a higher mechanical loss factor than the material of the other damping layer.

4. The ceiling mount as recited claim 1, wherein the materials of the damping layers are elastomers.

5. The ceiling mount as recited claim 4, wherein the materials of the damping layers are polyurethanes.

6. The ceiling mount as recited in claim 1, wherein the damping layers and the bracket plate of the interface lie substantially in horizontal planes of the ceiling mount, the damping layers comprising a lower damping layer and an upper damping layer located above the lower damping layer.

7. The ceiling mount as recited in claim 6, wherein the material of the lower damping layer has a higher static modulus of elasticity than the material of the upper damping layer.

8. The ceiling mount as recited in claim 6, wherein the dynamic moduli of elasticity of the upper and lower damping layers are approximately equal.

9. The ceiling mount as recited in claim 6, wherein the material of the upper damping layer has a static modulus of elasticity between about 2 N/mm² and 6 N/mm².

10. The ceiling mount as recited in claim 9, wherein the material of the upper damping layer has a static modulus of elasticity between about 3 N/mm² and 5 N/mm².

11. The ceiling mount as recited in claim 6, wherein the material of the lower damping layer has a static modulus of elasticity between about 4 N/mm² and 10 N/mm².

12. The ceiling mount as recited in claim 11, wherein the material of the lower damping layer has a static modulus of elasticity between about 5 N/mm² and 6 N/mm².

13. The ceiling mount as recited in claim 1, wherein the damping material of at least one of the damping layers is an elastomer foam having open and closed cells.

14. The ceiling mount as recited in claim 13, wherein the damping material of at least one of the damping layers is polyurethane.

15. The ceiling mount as recited in claim 1, wherein the ceiling mount further includes a ceiling attachment means for anchoring the ceiling mount to a ceiling and a support arm adapted to carry a surgical microscope, wherein the damping interface is disposed between the ceiling attachment means and the support arm.

16. The ceiling mount as recited in claim 1, wherein the ceiling mount further includes a support arm having a plurality of articulated members, and the damping interface is disposed between two of the articulated members of the support arm.

17. The ceiling mount as recited in claim 1, wherein a plurality of damping interfaces are provided.

18. The ceiling mount as recited in claim 1, wherein the damping interface further includes an upper housing plate, a lower housing plate, and a plurality of clamping bolts, wherein the damping layers and the bracket plate are clamped between the upper housing plate and the lower housing plate by the plurality of clamping bolts.

19. The ceiling mount as recited in claim 18, wherein a radial clearance is provided between each of the clamping bolts and the bracket plate.

20. The ceiling mount as recited in claim 19, wherein the radial clearances are filled with elastic elements.

21. The ceiling mount as recited in claim 20, wherein the elastic elements are O-rings.
